(19) United States
(12) Patent Application Publication
(10) Pub. No.: US 2023/0022908 A1
(43) Pub. Date: Jan. 26, 2023

(54) MULTIPLE COMPONENT CARRIER SCHEDULING PARAMETER FOR DCI SCHEDULING MULTIPLE COMPONENT CARRIERS

(71) Applicant: QUALCOMM Incorporated, San Diego, CA (US)

(72) Inventors: Fang Yuan, Beijing (CN); Yan Zhou, San Diego, CA (US); Tao Luo, San Diego, CA (US)

(21) Appl. No.: 17/758,497

(22) PCT Filed: Jan. 20, 2020
(86) PCT No.: PCT/CN2020/073270

§ 371 Date: Jul. 7, 2022

(51) Int. Cl. H04W 72/12; H04L 5/00

(52) U.S. Cl. CPC H04W 72/1289; H04L 5/0044; H04L 5/0094

(57) ABSTRACT

In a first aspect, a method of wireless communication includes receiving, by a user equipment (UE) from a first network entity, a multiple component carrier (CC) signaling message including multiple CC scheduling information. The method also includes receiving, by the UE from, a downlink control information transmission indicating a downlink control information indication for multiple CCs, and determining a first downlink control information parameter for a first CC and a second downlink control information parameter for a second CC based on the downlink control information indication and the multiple CC scheduling information. The method further includes receiving, from the first network entity, a first downlink transmission for the first CC based on the first downlink control information parameter, and receiving, from a second network entity, a second downlink transmission for the second CC based on the second downlink control information parameter. In other aspects, uplink transmissions may be sent.

### BACKGROUND

### Field

Aspects of the present disclosure relate generally to wireless communication systems, and more particularly, to carrier aggregation and multiple component carrier operation.

### Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In a particular aspect, a method of wireless communication includes receiving, by a user equipment (UE) from a first network entity, a multiple component carrier (CC) signaling message including multiple CC scheduling information; receiving, by the UE from the first network entity, a downlink control information transmission indicating a downlink control information indication for multiple CCs; determining, by the UE, a first downlink control information parameter for a first CC and a second downlink control information parameter for a second CC based on the downlink control information indication and the multiple CC scheduling information; receiving, by the UE from the first network entity, a first downlink transmission for the first CC based on the first downlink control information parameter; and receiving, by the UE from a second network entity, a second downlink transmission for the second CC based on the second downlink control information parameter.

In another aspect, a method of wireless communication includes receiving, by a user equipment (UE) from a first network entity, a multiple component carrier (CC) signaling message including multiple CC scheduling information; receiving, by the UE from the first network entity, a downlink control information transmission indicating an uplink control information indication for multiple CCs; determining, by the UE, a first uplink control information parameter for a first CC and a second uplink control information parameter for a second CC based on the downlink control information indication and the multiple CC scheduling information; transmitting, by the UE from the first network entity, a first uplink transmission for the first CC based on the first uplink control information parameter; and transmitting, by the UE from a second network entity, a second uplink transmission for the second CC based on the second uplink control information parameter.

In another aspect, a method of wireless communication includes transmitting, by a network to a particular user equipment (UE), a multiple component carrier (CC) signaling message including multiple CC scheduling information; generating, by the network, a downlink control information indication configured to indicate a first downlink control information parameter for a first CC and a second downlink control information parameter based on the multiple CC scheduling information; transmitting, by the network, a downlink control information transmission including the downlink control information indication; transmitting, by the network to the particular UE, a first downlink transmission via a first CC based on the first downlink control information parameter; and transmitting, by the network to the particular UE, a second downlink transmission via a second CC based on the second downlink control information parameter.

In another aspect, a method of wireless communication includes transmitting, by a network to a particular user equipment (UE), a multiple component carrier signaling message including multiple CC scheduling information; generating, by the network, a downlink control information indication configured to indicate a first uplink control information parameter for a first CC and a second uplink control information parameter based on the multiple CC scheduling information; transmitting, by the network, a downlink control information transmission including the uplink control information indication; receiving, by the network from the particular UE, a first uplink transmission via a first CC based on the first uplink control information parameter; and receiving, by the network from the particular UE, a second uplink transmission via a second CC based on the second uplink control information parameter.

Although example methods are illustrated above, the methods may be carried out, implemented, or performed by an apparatus or a non-transitory computer readable medium. The apparatus may include a processor and a memory configured to perform the actions recited in the above methods or means for performing the actions recited in the above methods.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system.

FIG. 2 is a block diagram illustrating a design of a base station and a UE configured according to one aspect of the present disclosure.

FIGS. 3A and 3B are diagrams illustrating examples different operating modes.

FIG. 4 is a block diagram illustrating an example of a wireless communications system that enables multi-CC codepoint operation.

FIG. 5 is a ladder diagram illustrating an example of a process flow for an example of multi-CC codepoint scheduling operations.

FIG. 6 is a ladder diagram illustrating an example of a process flow for a first example of multi-CC codepoint operation.

FIG. 7 is a ladder diagram illustrating an example of a process flow for a second example of multi-CC codepoint operation.

FIG. 8 is a ladder diagram illustrating an example of a process flow for a third example of multi-CC codepoint operation.

FIG. 9 is a block diagram illustrating an example of a field layout for downlink control messages.

FIG. 10 is a block diagram illustrating example blocks executed by a UE.

FIG. 11 is a block diagram illustrating another example of blocks executed by a UE.

FIG. 12 is a block diagram illustrating example blocks executed by a network entity.

FIG. 13 is a block diagram illustrating another example of blocks executed by a network entity.

The Appendix provides further details regarding various embodiments of this disclosure and the subject matter therein forms a part of the specification of this application.

### DETAILED DESCRIPTION

The detailed description set forth below, in connection with the appended drawings and appendix, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

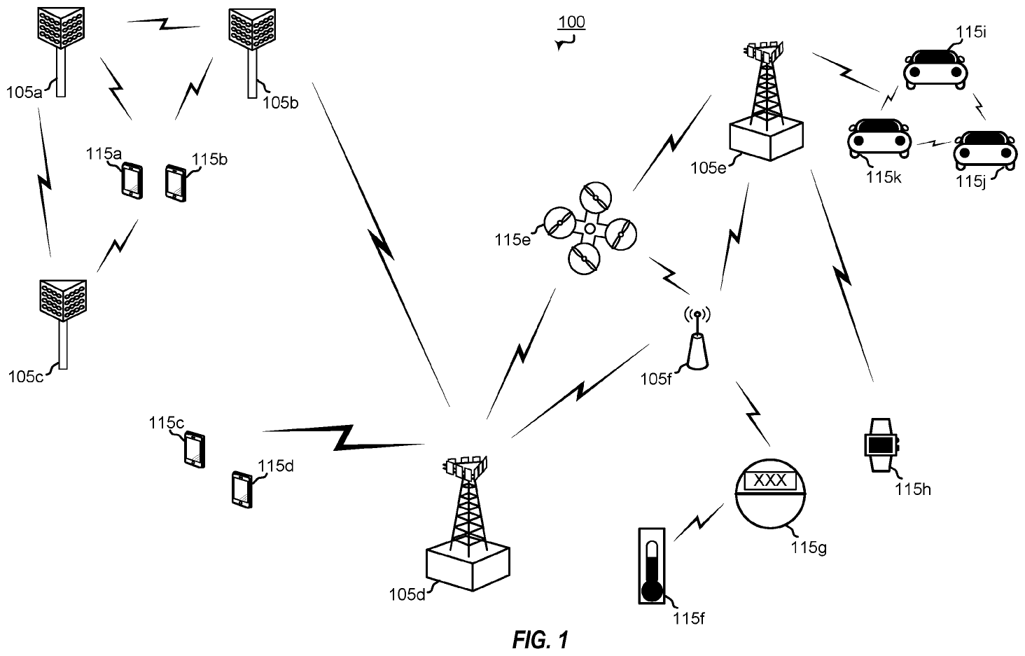

FIG. 1 is a block diagram illustrating 5G network 100 including various base stations and UEs configured according to aspects of the present disclosure. The 5G network 100 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, the base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

The 5G network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time.

The UEs 115 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE may be a device that includes a Universal Integrated Circuit Card (UICC). In another aspect, a UE may be a device that does not include a UICC. In some aspects, UEs that do not include UICCs may also be referred to as internet of everything (IoE) or internet of things (IoT) devices. UEs 115a-115d are examples of mobile smart phone-type devices accessing 5G network 100 A UE may also be a machine specifically configured for connected communication, including machine type communication (MTC), enhanced MTC (eMTC), narrowband IoT (NB-IoT) and the like. UEs 115e-115k are examples of various machines configured for communication that access 5G network 100. A UE may be able to communicate with any type of the base stations, whether macro base station, small cell, or the like. In FIG. 1, a lightning bolt (e.g., communication links) indicates wireless transmissions between a UE and a serving base station, which is a base station designated to serve the UE on the downlink and/or uplink, or desired transmission between base stations, and backhaul transmissions between base stations.

In operation at 5G network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

5G network 100 also support mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through 5G network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. 5G network 100 may also provide additional network efficiency through dynamic, low-latency TDD/FDD communications, such as in a vehicle-to-vehicle (V2V) mesh network between UEs 115i-115k communicating with macro base station 105e.

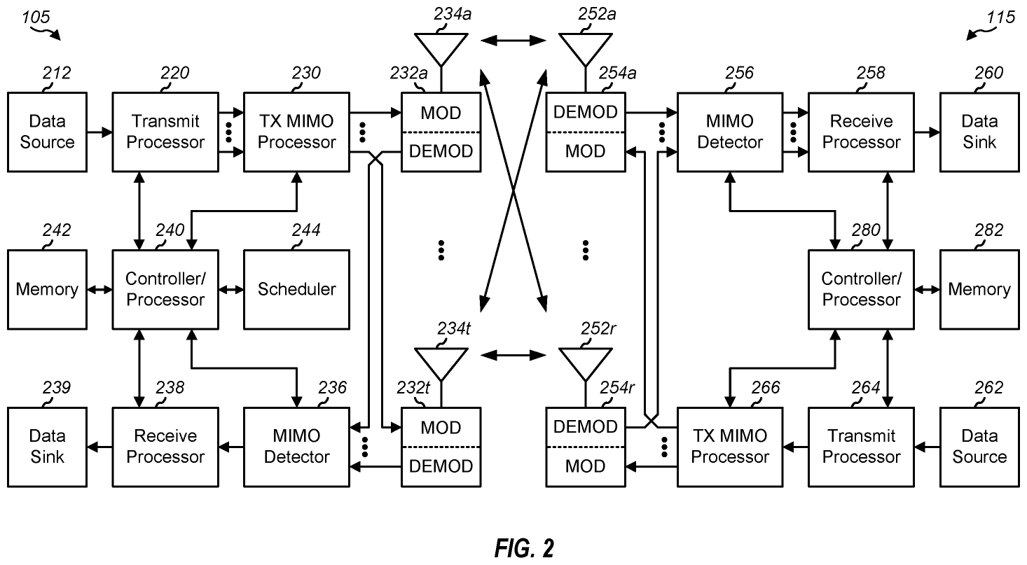

FIG. 2 shows a block diagram of a design of a base station 105 and a UE 115, which may be one of the base station and one of the UEs in FIG. 1. At the base station 105, a transmit processor 220 may receive data from a data source 212 and control information from a controller/processor 240. The control information may be for the PBCH, PCFICH, PHICH, PDCCH, EPDCCH, MPDCCH etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MIMO detector 236 if applicable, and further processed by a receive processor 238 to obtain decoded data and control information sent by the UE 115. The processor 238 may provide the decoded data to a data sink 239 and the decoded control information to the controller/processor 240.

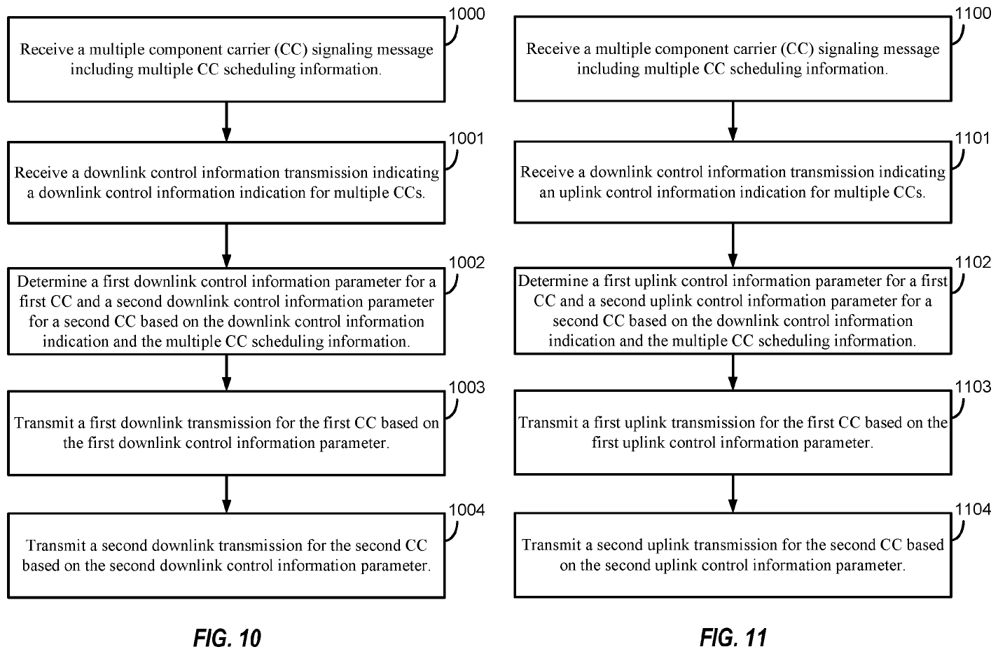

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIGS. 10-13, and/or other processes for the techniques described herein. The memories 242 and 282 may store data and program codes for the base station 105 and the UE 115, respectively. A scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 of the 5g network 100 (in FIG. 1) may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Use of a medium-sensing procedure to contend for access to an unlicensed shared spectrum may result in communication inefficiencies. This may be particularly evident when multiple network operating entities (e.g., network operators) are attempting to access a shared resource. In the 5G network 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

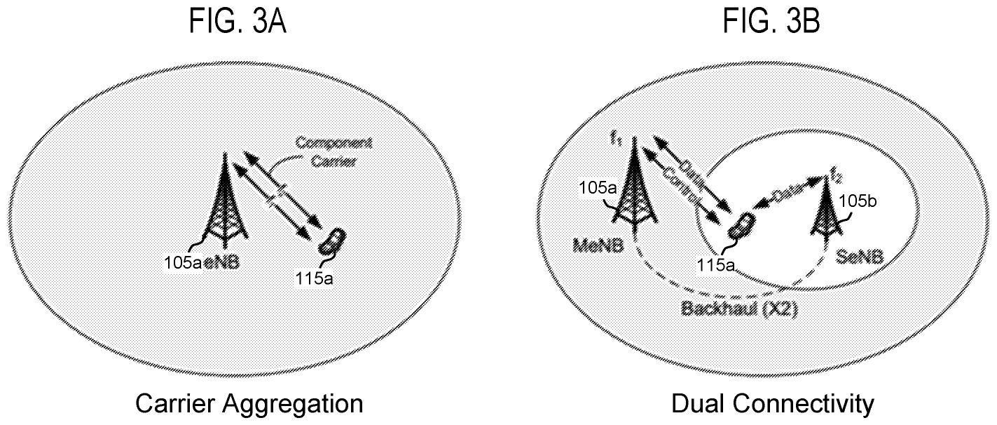

Referring to FIGS. 3A and 3B, examples different operating modes are illustrated. FIG. 3A corresponds to a diagram for carrier aggregation and FIG. 3B corresponds to a diagram for dual connectivity. In FIG. 3A, a diagram illustrating carrier aggregation is illustrated. FIG. 3A depicts one base station 105a which communicates with UE 115a. Base station 105a may transmit data and control information; base station 105a may transmit (and receive) information using different equipment or settings (such as different frequencies). In carrier aggregation, the network, that is base station 105a, includes primary and secondary cells, such as primary and secondary serving cells.

In FIG. 3B, a diagram illustrating dual connectivity is illustrated. FIG. 3B depicts two base stations, 105a and 105b which communicate with UE 115a. UE 115a communicates data with both base stations and control information with one base station, main base station 105a. In dual connectivity, the network includes primary and secondary cell groups, as opposed to primary and secondary cells in carrier aggregation. Each group, primary or secondary, may include primary and secondary cells. Thus, such setups where each group includes primary and secondary cells may utilize both carrier aggregation and dual connectivity.

In conventional operation, a DCI transmission schedules transmissions for a single component carrier (CC) or multiple CCs. When scheduling transmissions for multiple CCs, each parameter is signalled individually per CC (referred to as individual-CC scheduling by an individual-CC scheduling parameter). This may increase DCI length and singling overhead.

In the implementations described herein, for a DCI transmission scheduling multiple CCs, a parameter (e.g., a multi-CC scheduling parameter) can be included/signalled for one or more parameters for two or more CCs. The multi-CC scheduling parameter has candidate values (e.g., codepoints) that are mapped to a set of values of individual-CC scheduling parameters for different CCs. To illustrate, the multi-CC scheduling parameter can be a multi-CC TCI codepoint. Instead of signaling individual-CC TCI codepoints, a single multi-CC TCI codepoint can be signalled with each candidate value mapped to multiple individual-CC TCI ID values on respective CCs.

In some implementations, multi-CC TCI codepoints can be used for DL beam indication for downlink transmission, such as PDCCH, CSI-RS, and/or PDSCH. In addition or in the alternative, multi-CC spatial relation information, multi-CC UL TCI codepoints, or both, can be used for UL beam indication for uplink transmission, such as PUCCH, PUSCH, SRS, and/or PRACH.

As another illustration, instead of signaling individual-CC PDSCH scheduling offset K0 as in Rel-15/16, a single multi-CC PDSCH scheduling offset K0 in a DCI can be signalled for the offset between the DCI and the scheduled PDSCH transmission where each candidate value is mapped to multiple individual-CC K0 values.

In some implementations, multi-CC K1 codepoints in a DCI can be used for signaling/indicating offsets between the scheduled PDSCH and a corresponding PUCCH. In some implementations, multi-CC K2 codepoints in a DCI can be used for signaling/indicating offsets for between the DCI and the scheduled PUSCH.

The multi-CC scheduling parameters may be signalled by/included in and/or correspond to the fields for individual-CC scheduling parameters in existing DCI formats, e.g. format 0_0, 0_1, 1_0, 1_1. The mapping between multi-CC scheduling parameter value to individual-CC scheduling parameter value(s) can be updated by gNB or UE via RRC/MAC-CE/DCI. For example, a list of multi-CC scheduling parameters can be configured by RRC signaling, and a subset of the list can be selected by the MAC-CE signaling. The DCI codepoints for the multi-CC scheduling parameters are mapped in order to the multi-CC scheduling parameters in the selected subset of the list.

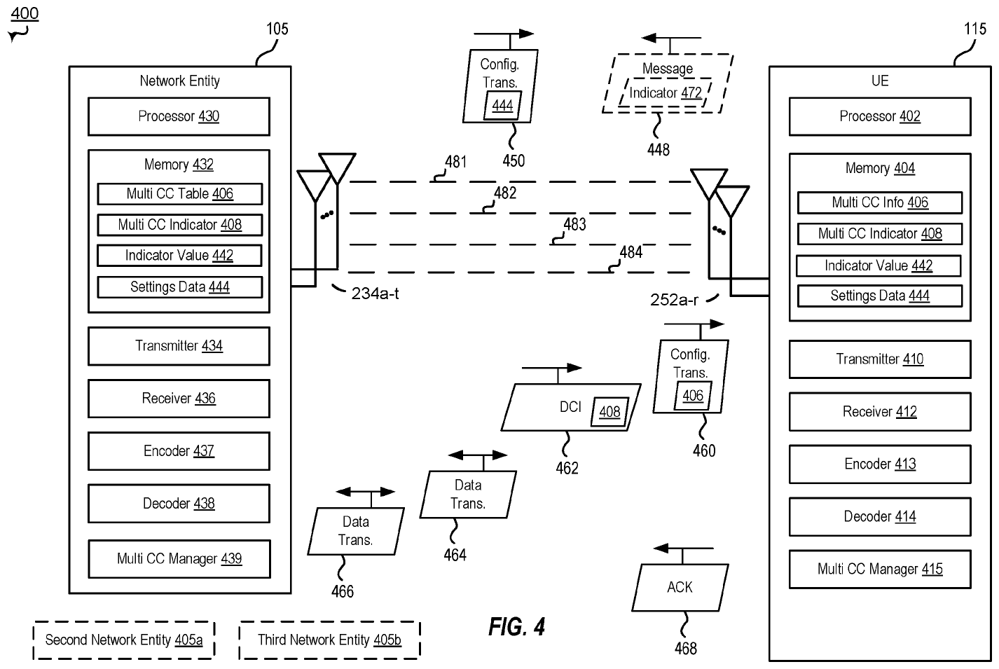

FIG. 4 illustrates an example of a wireless communications system 400 that supports multi-CC scheduling operations. In some examples, wireless communications system 400 may implement aspects of wireless communication system 100. For example, wireless communications system 400 includes network entity 105 (such as a network system or base station) and UE 115, and optionally includes second network entity 405a (such as a TRP of the base station or a second base station), third network entity 405b, a servicing device 407, or a combination thereof. Multi-CC scheduling operation may enable more efficient multiple carrier or cell operation and may increase reliability and reduce latency and overhead as compared to single CC operation and per CC indication.

Network entity 105 and UE 115 may be configured to communicate via frequency bands, such as FR1 having a frequency of 410 to 7125 MHz, FR2 having a frequency of 24250 to 52600 MHz for mm-Wave, or bands above FR2. In some implementations, the FR2 frequency bands may be limited to 52.6 GHz. While in some other implementations, the FR2 frequency bands may have a frequency of 300 GHz or more. It is noted that sub-carrier spacing (SCS) may be equal to 15, 30, 60, or 120 kHz for some data channels. Network entity 105 and UE 115 may be configured to communicate via one or more component carriers (CCs), such as representative first CC 481, second CC 482, third CC 483, and fourth CC 484. Although four CCs are shown, this is for illustration only, as more or fewer than four CCs may be used. One or more CCs may be used to communicate a Physical Downlink Control Channel (PDCCH), a Physical Downlink Shared Channel (PDSCH), a Physical Uplink Control Channel (PUCCH), or a Physical Uplink Shared Channel (PUSCH).

In some implementations, such transmissions may be scheduled by dynamic grants. In some other implementations, such transmissions may be scheduled by one or more periodic grants and may correspond to semi-persistent scheduling (SPS) grants or configured grants of the one or more periodic grants. The grants, both dynamic and periodic, may be preceded or indicated by a pre-grant transmission or a message with a UE identifier (UE-ID). In some implementations, the pre-grant transmission may include a UE-ID. The pre-grant transmission or UE-ID message may be configured to activate one or more UEs such that the UEs will transmit a first reference signal, listen/monitor for a second reference signal, or both. The pre-grant transmission or UE-ID message may be sent during a contention period, such as contention period 310, and initiate a contention procedure.

Each periodic grant may have a corresponding configuration, such as configuration parameters/settings. The periodic grant configuration may include SPS configurations and settings. Additionally, or alternatively, one or more periodic grants (such as SPS grants thereof) may have or be assigned to a CC ID, such as intended CC ID.

Each CC may have a corresponding configuration, such as configuration parameters/settings. The configuration may include bandwidth, bandwidth part, hybrid automatic repeat request (HARM) process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC also may have corresponding management functionalities, such as, beam management, BWP switching functionality, or both. In some implementations, two or more CCs are quasi co-located, such that the CCs have the same beam or same symbol.

In some implementations, control information may be communicated via network entity 105 and UE 115. For example, the control information may be communicated suing MAC-CE transmissions, RRC transmissions, DCI, transmissions, another transmission, or a combination thereof.

UE 115 includes processor 402, memory 404, transmitter 410, receiver 412, encoder, 413, decoder 414, Multiple CC Manager 415, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 also may be configured to store Multiple CC information 406, a Multiple CC indicator 408, an indicator value 442, settings data 444, or a combination thereof, as further described herein.

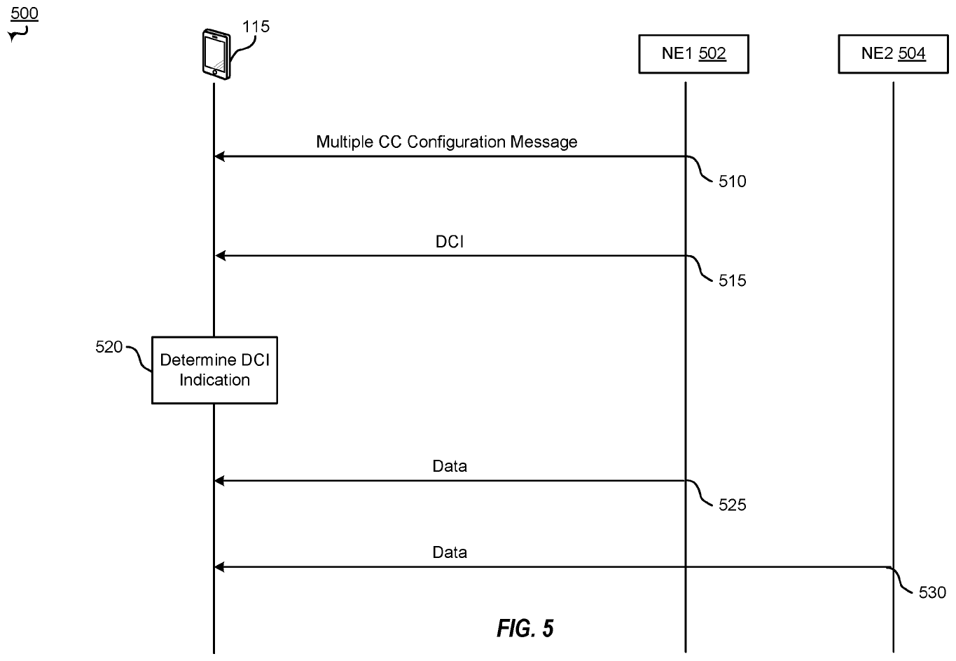

The Multiple CC information 406 includes or corresponds to list of values to map a codepoint vales to transmission information, such as shown in FIGS. 5-7. The Multiple CC indicator 408 includes or corresponds to codepoint value of a DCI. The indicator value 442 includes or corresponds to decoded codepoint value, as shown in FIGS. 5-7. The settings data 444 includes or corresponds to data which is used by UE 115 to determine a multi-CC indication operation mode, a particular mapping list, or other settings of multi-CC indication operation.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode, such as encode or decode transmissions, respectively. Multiple CC Manager 415 may be configured to determine an indicator value 442 based on multiple CC information 406 (e.g., a particular parameter list) and a multiple CC indicator 408. The indicator value 442 may indicate downlink information for multiple transmissions on multiple CCs. Such multiple CC indicator enables enhanced multi-CC operation and reduces signaling overhead as compared to a plurality of individual indications.

Network entity 105 includes processor 430, memory 432, transmitter 434, receiver 436, encoder 437, decoder 438, Multiple CC Manager 439, and antennas 234a —t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store multiple CC information 406, multiple CC indicator 408, indicator value 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, network entity 105 may be configured to transmit or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of network entity 105 described with reference to FIG. 2. Encoder 437, and decoder 438 may include the same functionality as described with reference to encoder 413 and decoder 414, respectively. Multiple CC Manager 439 may include similar functionality as described with reference to Multiple CC Manager 415.

During operation of wireless communications system 400, network entity 105 may determine that UE 115 has multi-CC scheduling operation capability. For example, UE 115 may transmit a message 448, such as a capabilities message, that includes a multi-CC scheduling operation indicator 472. Indicator 472 may indicate multi-CC scheduling operation capability or a particular type of multi-CC scheduling operation, such as uplink, downlink, or both. In some implementations, network entity 105 sends control information to indicate to UE 115 that multi-CC scheduling operations are to be used. For example, in some implementations, message 448 (or another message, such as a response or a trigger message) is transmitted by the network entity 105.

In the example of FIG. 4, network entity 105 transmits an optional configuration transmission 450. The configuration transmission 450 may include or indicate a multi-CC scheduling operation configuration, such as settings data 444. The configuration transmission 450 (such as settings data 444 thereof) may indicate multi-CC scheduling operation format, a parameter list, etc.

After transmission of the message 448, the configuration transmission 450 (such as a RRC message or a DCI), or both, multi-CC scheduling operations may be established. In the example of FIG. 4, the network entity 115 transmits a configuration transmission 460 to UE 115. The configuration transmission 460 includes multi-CC scheduling information, multiple CC information 460, such as a multi-CC scheduling parameter list of parameter values. After transmission of the configuration transmission 460, the network entity transmits a DCI transmission 462. The DCI transmission 462 may include or indicate a multiple CC indicator 408 which identifies the corresponding downlink information for transmissions via multiple CCs.

Additionally, the UE 115 determines an indicator value 442 and determines downlink information based on the indicator value 442. The UE 115 may receive data transmissions (downlink transmissions) or transmit data transmissions (uplink transmissions) according to the DCI 460 and the multiple CC indicator 408. In the example of FIG. 4, the UE 115 receives a first data transmission 462 from the network entity 105 on a first CC and a second data transmission 464 from the second network entity 405a on a second CC. The first and second data transmissions are sent and/or received based on the multiple CC indicator 408. For example, reference signals or offsets may be indicated for multiple or each CC. The UE 115 may optionally send one or more acknowledgment messages (ACKs) responsive to one or more messages from the network entity 105 or second network entity 405a.

FIG. 5 is a ladder diagram illustrating an example of a process flow for an example of multi-CC codepoint scheduling operations. Referring to FIG. 5, a process flow 500 is illustrated that supports multi-CC codepoint operation in accordance with aspects of the present disclosure. In some examples, process flow 500 may implement aspects of a wireless communications system 100 or 400. For example, a network entity or entities and a UE may perform one or more of the processes described with reference to process flow 500. Network entities may communicate with UE 115 by transmitting and receiving signals through TRPs. Alternative examples of the following may be implemented, where some steps are performed in a different order than described or are not performed at all. In some cases, steps may include additional features not mentioned below, or further steps may be added.

At 510, UE 115 may receive from a first network entity 502 (e.g., a first gNB or a first TRP of a gNB), a multi-CC scheduling parameter configuration transmission. The multi-CC scheduling parameter configuration transmission may include a multi-CC scheduling parameter list for a particular parameter or parameters. Alternatively, the multi-CC scheduling parameter configuration transmission may include a plurality of multi-CC scheduling parameter lists. For example, from the first network entity 502, a list of multi-CC scheduling parameters can be configured by RRC signaling, and a subset of the list can be selected by the MAC-CE signaling. The DCI codepoints for the multi-CC scheduling parameters are mapped in order to the multi-CC scheduling parameters in the selected subset of the list. In other implementations, the multi-CC scheduling parameter configuration transmission may include an indication or a selection of a previously stored or received multi-CC scheduling parameter list. To illustrate, the multi-CC scheduling parameter configuration transmission may indicate a list of multi-CC TCI ID number. The multi-CC scheduling parameter configuration transmission may include or correspond to a DCI transmission, a MAC CE transmission, or a RRC transmission.

At 515, UE 115 may receive a DCI transmission from the first network entity 502 including a multi-CC scheduling parameter. For example, the DCI transmission includes a downlink control information indication for multiple downlink transmission on multiple CCs. To illustrate, the DCI transmission includes a multi-CC parameter codepoint, such as a multi-CC TCI codepoint or a multi-CC offset codepoint (e.g., K0-K2). Although the DCI transmission is received form the first network entity 502 in the example of FIG. 5, the DCI transmission may be received from another network entity, such as the second network entity 504 (e.g., a second gNB or a second TRP of a gNB).

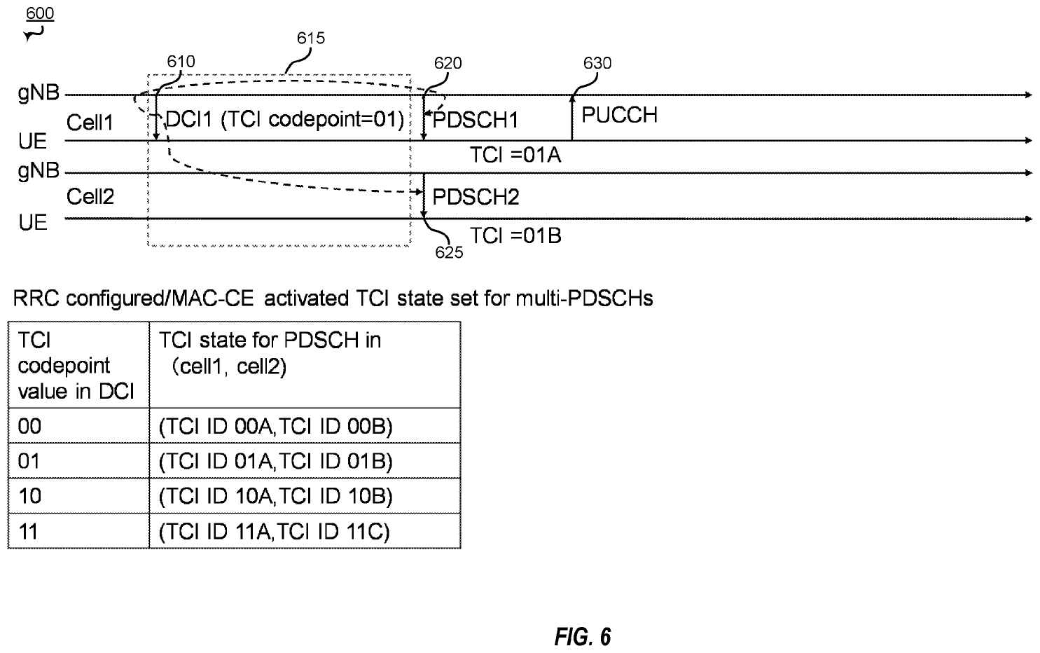

At 520, UE 115 may determine downlink transmission scheduling information for multiple downlink transmissions for multiple CCs. For example, the UE 115 may determine first and second downlink information for a particular DCI parameter based on multi-CC scheduling parameter codepoint. Detailed explanation and examples of determining multiple parameter information on a single codepoint are described with reference to FIGS. 6-8.

At 525, UE 115 may receive from the first network entity 502 a first downlink data transmission (e.g., first PDSCH) for a first component carrier according to the first downlink information.

At 530, UE 115 may receive from a second network entity 504 a second downlink data transmission (e.g., second PDSCH transmission) for a second component carrier according to the second downlink information.

FIG. 6 is a ladder diagram illustrating an example of a process flow for a first example of multi-CC codepoint operation. Referring to FIG. 6, a process flow 600 is illustrated that supports multi-CC codepoint operation in accordance with aspects of the present disclosure. In some examples, process flow 600 may implement aspects of a wireless communications system 100 or 400. For example, a network entity or entities and a UE may perform one or more of the processes described with reference to process flow 600. Network entities may communicate with UE 115 by transmitting and receiving signals through TRPs. Alternative examples of the following may be implemented, where some steps are performed in a different order than described or are not performed at all. In some cases, steps may include additional features not mentioned below, or further steps may be added.

At 610, UE 115 may receive from a gNB, a DCI transmission. In the example of FIG. 6, the DCI includes a multi-CC TCI codepoint.

At 615, UE 115 may determine downlink transmission for multiple downlink transmissions for multiple CCs. In the example of FIG. 6, UE 115 determines two reception beams associated with two downlink reference signals (RS) for two CC's based on a single TCI codepoint (e.g., codepoint value). To illustrate, the DCI includes a TCI codepoint of 01. The UE 115 uses a list to decode the TCI codepoint of 01 for each CC. As illustrated in the example of FIG. 6, the TCI codepoint value of 01 indicates a TCI ID of 01A for CC1 and 01B for CC2, where TCI IDs of 01A and 01B are determined by the multi-CC TCI list configured by RRC signaling and/or selected by MAC-CE signaling.

At 620, UE 115 may receive from the gNB network entity a first PDSCH for a first component carrier. The first PDSCH is received based on a beam associated with a reference signal, RS1, that corresponds to the TCI ID of 01A.

At 625, UE 115 may receive from the gNB a second PDSCH transmission for a second component carrier. The second PDSCH is received based on a beam associated with a reference signal, RS1, that corresponds to the TCI ID of 01B.

At 630, UE 115 may transmit an ACK via a PUCCH to the gNB via the first or second component carrier. As illustrated in FIG. 6, the ACK is transmitted on cell 1 or the first component carrier.

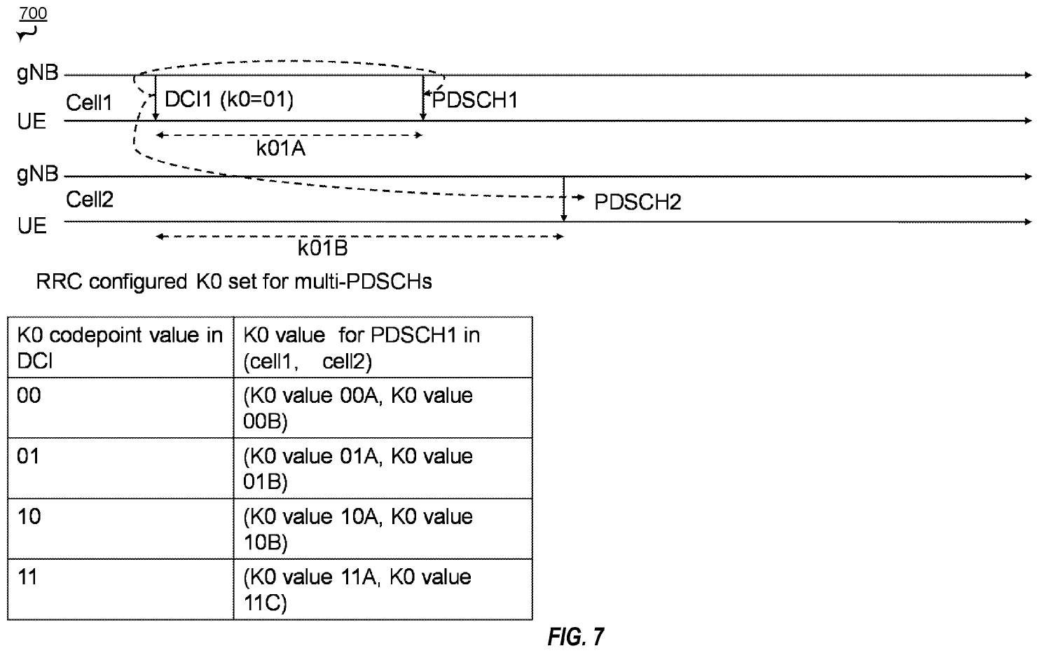

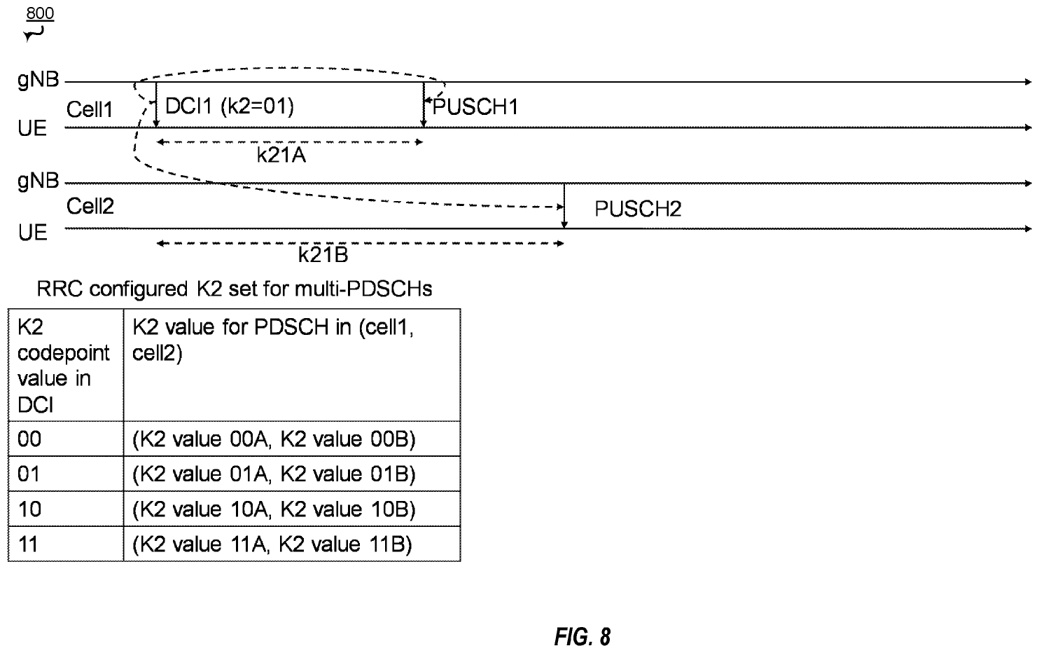

FIGS. 7 and 8 are ladder diagrams illustrating an example of process flows for second and third examples of multi-CC codepoint operation. FIG. 7 illustrates an example of a multi-CC K0 codepoint value, and FIG. 8 illustrates an example of a K2 codepoint value. Although downlink examples are illustrated in FIGS. 6-8, in other implementations, uplink multi-CC indicators may be used. To illustrate a DCI (e.g., 610) may schedule uplink transmissions on multiple CCs. Additionally, although certain DCI parameters are shown in the example of FIGS. 6-8, other DCI parameters may be used for multi-CC operation, such as at least K1.

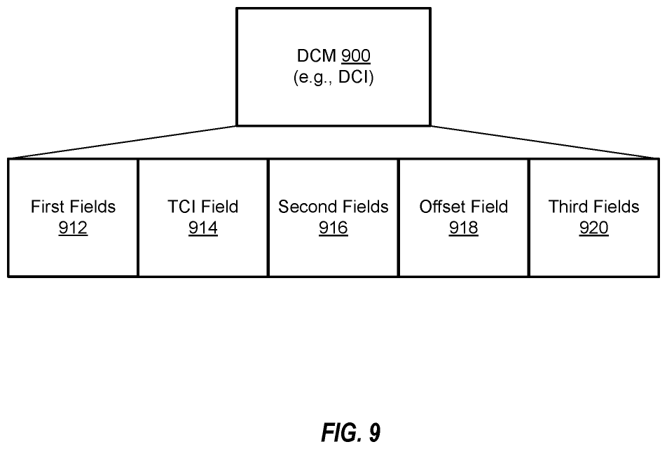

Referring to FIG. 9, an example of a field layout for downlink control messages is illustrated. The downlink control message 900 may include or correspond to the configuration messages and/or DCI transmission of FIGS. 4-8. The downlink control message 900 includes one or more fields. As illustrated in FIG. 9, the downlink control message 900 is a DCI. A DCI (or DCI transmission) may have multiple different types or formats, such as Format 0_0, 0_1, 1_0, 1_1, etc. In the example illustrated in FIG. 9, the downlink control message 900 includes one or more first fields 912, a TCI field 914, one or more second fields 916, an offset field 918, and one or more third fields 920. Although fields 912-920 are illustrated in the example of FIG. 9, one of more of such fields may be optional.

The TCI state field 914 may identify or indicate a value for TCI state for one or more downlink transmissions for multiple CCs, such as downlink data transmissions (e.g., PDSCH transmissions). For example, the TCI state field 914 indicates a value for TCI state for each PDSCH transmission or indicates a value for TCI state for each PUSCH transmission on multiple CCs. In a particular implementation, the TCI state field 914 is a 2 bit field.

The TCI state field 914 may indicate the values for the TCI states directly. For example, a value of the TCI state field 914, i.e., a value identified by bits thereof, is or indicates the value for one or more of the TCI states of the multiple CCs. To illustrate, a bit of the TCI state field 914 corresponds to a first TCI state value for a first CC and a second TCI state value for a second CC.

The TCI state field 914 may indicate the TCI state values indirectly, i.e., identify the TCI state for each CC by indicating a member of set or a value or location of a list. For example, a value of the TCI state field 914, i.e., a value identified by bits thereof, indicates a particular member of a set of TCI state values, and a value (e.g., a second value) of the particular member of the set indicates the TCI state values. To illustrate, a bit sequence of 11 illustrates an 4^{th} member of a set. Additionally, or alternatively, the downlink control message 900 includes a SRI field, similar to the TCI field 914, which identifies or indicates a value for SRI for one or more CCs.

The offset field 918 may identify or indicate a value for one or more offsets for one or more CCs. For example, the offset field 918 may indicate a K0 offset value, a K1 offset value, a K2, offset value, or a combination thereof. The offset field 918 indicates a value for at least one offset for each CC. In a particular implementation, the offset field 918 is a 2 bit field. Although the TCI state field 914 is illustrated as being separate from the offset field 918, the fields 914 and 918 may be contiguous fields. Additionally or alternatively, one or more of fields 914 or 918 may be a first field or a last field.

In some implementations, the offset field 918 indirectly indicates the offset value, similar to as described with reference to the TCI field 914. Additional fields or fields 912, 916, or 920 may indicates a value for SRI, a value for RV, a value for TDRA, or a combination thereof, for each CC (e.g., each downlink data transmission on each CC).

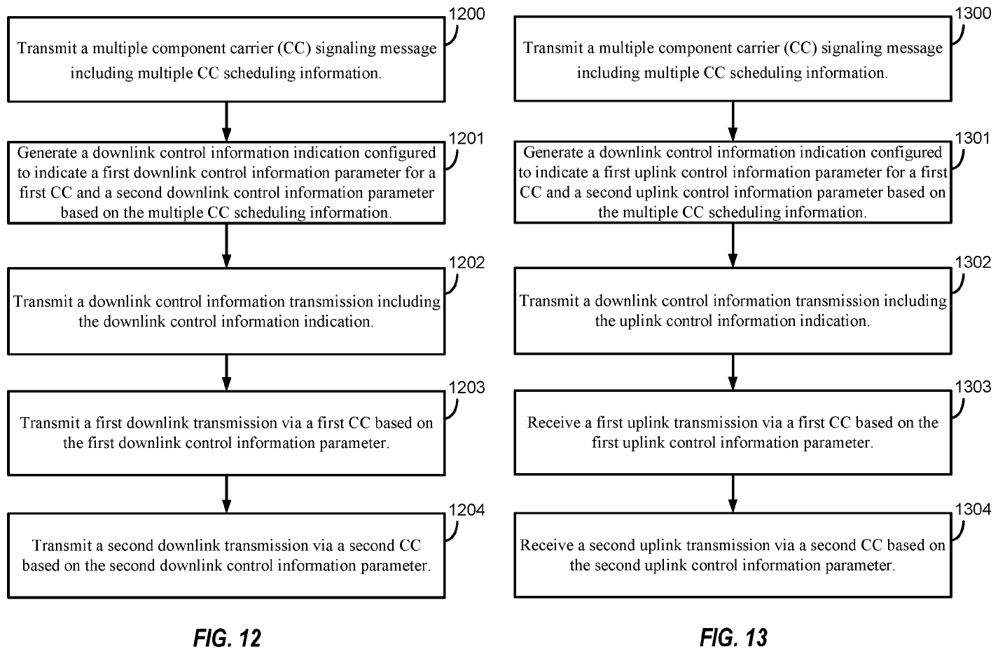

FIGS. 10 and 11 are block diagrams illustrating example blocks executed by a UE configured according to an aspect of the present disclosure. FIG. 10 illustrates a downlink multiple CC indicator example and FIG. 11 illustrates an uplink multiple CC indicator example. FIGS. 12 and 13 are block diagrams illustrating example blocks executed by a network configured according to an aspect of the present disclosure. FIG. 12 illustrates a downlink multiple CC indicator example and FIG. 13 illustrates an uplink multiple CC indicator example.

Referring to FIG. 10, at 1000, a method of wireless communication includes receiving, by a user equipment (UE) from a first network entity, a multiple component carrier (CC) signaling message including multiple CC scheduling information.

At 1001, the method of wireless communication also includes receiving, by the UE from the first network entity, a downlink control information transmission indicating a downlink control information indication for multiple CCs.

At 1002, the method of wireless communication includes determining, by the UE, a first downlink control information parameter for a first CC and a second downlink control information parameter for a second CC based on the downlink control information indication and the multiple CC scheduling information.

At 1003, the method of wireless communication also includes receiving, by the UE from the first network entity, a first downlink transmission for the first CC based on the first downlink control information parameter.

At 1004, the method of wireless communication further includes receiving, by the UE from a second network entity, a second downlink transmission for the second CC based on the second downlink control information parameter.

Referring to FIG. 11, at 1100, a method of wireless communication includes receiving, by a user equipment (UE) from a first network entity, a multiple component carrier (CC) signaling message including multiple CC scheduling information.

At 1101, the method of wireless communication also includes receiving, by the UE from the first network entity, a downlink control information transmission indicating an uplink control information indication for multiple CCs.

At 1102, the method of wireless communication includes determining, by the UE, a first uplink control information parameter for a first CC and a second uplink control information parameter for a second CC based on the downlink control information indication and the multiple CC scheduling information.

At 1103, the method of wireless communication also includes transmitting, by the UE from the first network entity, a first uplink transmission for the first CC based on the first uplink control information parameter.

At 1104, the method of wireless communication further includes transmitting, by the UE from a second network entity, a second uplink transmission for the second CC based on the second uplink control information parameter.

Referring to FIG. 12, at 1200, a method of wireless communication includes transmitting, by a network to a particular user equipment (UE), a multiple component carrier (CC) signaling message including multiple CC scheduling information.

At 1201, the method of wireless communication also includes generating, by the network, a downlink control information indication configured to indicate a first downlink control information parameter for a first CC and a second downlink control information parameter based on the multiple CC scheduling information.

At 1202, the method of wireless communication includes transmitting, by the network, a downlink control information transmission including the downlink control information indication.

At 1203, the method of wireless communication also includes transmitting, by the network to the particular UE, a first downlink transmission via a first CC based on the first downlink control information parameter.

At 1204, the method of wireless communication further includes transmitting, by the network to the particular UE, a second downlink transmission via a second CC based on the second downlink control information parameter.

Referring to FIG. 13, at 1300, a method of wireless communication includes transmitting, by a network to a particular user equipment (UE), a multiple component carrier signaling message including multiple CC scheduling information.

At 1301, the method of wireless communication also includes generating, by the network, a downlink control information indication configured to indicate a first uplink control information parameter for a first CC and a second uplink control information parameter based on the multiple CC scheduling information.

At 1302, the method of wireless communication includes transmitting, by the network, a downlink control information transmission including the uplink control information indication.

At 1303, the method of wireless communication also includes receiving, by the network from the particular UE, a first uplink transmission via a first CC based on the first uplink control information parameter.

At 1304, the method of wireless communication further includes receiving, by the network from the particular UE, a second uplink transmission via a second CC based on the second uplink control information parameter.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 10-13 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication comprising:
receiving, by a user equipment (UE) from a first network entity, a multiple component carrier (CC) signaling message including multiple CC scheduling information;
receiving, by the UE from the first network entity, a downlink control information transmission indicating a downlink control information indication for multiple CCs;
determining, by the UE, a first downlink control information parameter for a first CC and a second downlink control information parameter for a second CC based on the downlink control information indication and the multiple CC scheduling information;
receiving, by the UE from the first network entity, a first downlink transmission for the first CC based on the first downlink control information parameter; and
receiving, by the UE from a second network entity, a second downlink transmission for the second CC based on the second downlink control information parameter.

2. The method of claim 1, wherein the multiple CC scheduling information comprises a list of parameter values configured to indicate scheduling parameter information for a particular downlink scheduling parameter for the multiple CCs.

3. The method of claim 1, wherein the multiple CC signaling message includes second multiple CC scheduling information configured to indicate second scheduling parameter information for a second downlink scheduling parameter for the multiple CCs.

4. (canceled)

5. The method of claim 1, wherein determining the first downlink control information parameter and the second downlink control information parameter includes:
determining a multiple CC codepoint from the downlink control information transmission;
determining a first parameter value for the first CC based on the multiple CC codepoint and the multiple CC scheduling information; and
determining a second parameter value for the second CC based on the multiple CC codepoint and the multiple CC scheduling information.

6. The method of claim 5, wherein determining the first parameter value for the first CC includes performing a first mapping using a multiple CC parameter list of the multiple CC scheduling information, and wherein determining the second parameter value for the second CC includes performing a second mapping using the multiple CC parameter list.

7. The method of claim 6, wherein the multiple CC codepoint maps to two parameter values in the multiple CC parameter list, and wherein the first parameter value and the second parameter value have different values.

8-10. (canceled)

11. The method of claim 1, wherein the first and second downlink transmissions have different data or the same data.

12. (canceled)

13. The method of claim 1, wherein the multiple CC scheduling information indicates one or more of:
a reference signal information list;
a transmission configuration indicator (TCI) list; or
an offset timing information list, wherein the offset timing information list includes a physical downlink shared channel (PDSCH) offset timing list, a physical uplink control channel (PUCCH) offset timing list, or a physical uplink shared channel (PUSCH) offset timing list.

14-18. (canceled)

19. The method of claim 1, further comprising, prior to receiving the downlink control information transmission, transmitting, by the UE, a capabilities message indicating that the UE is configured for multiple CC scheduling parameter operation.

20. The method of claim 1, further comprising, prior to receiving the downlink control information transmission, receiving, by the UE, a configuration message from a network entity indicating multiple CC scheduling parameter operation is enabled.

21. The method of claim 1, further comprising, prior to receiving the downlink control information transmission, receiving, by the UE, a configuration message from a network entity indicating a particular type of multiple CC scheduling parameter operation.

22. (canceled)

23. The method of claim 1, further comprising:
receiving, by the UE from the first network entity, a second downlink control information transmission indicating an uplink control information indication for multiple CCs;
determining, by the UE, a first uplink control information parameter for the first CC and a second uplink control information parameter for the second CC based on the downlink control information indication and the multiple CC scheduling information;
transmitting, by the UE from the first network entity, a first uplink transmission for the first CC based on the first uplink control information parameter; and
transmitting, by the UE from the second network entity, a second uplink transmission for the second CC based on the second uplink control information parameter.

24-27. (canceled)

28. A method of wireless communication comprising:
transmitting, by a network to a particular user equipment (UE), a multiple component carrier (CC) signaling message including multiple CC scheduling information;
generating, by the network, a downlink control information indication configured to indicate a first downlink control information parameter for a first CC and a second downlink control information parameter for a second CC based on the multiple CC scheduling information;
transmitting, by the network, a downlink control information transmission including the downlink control information indication;
transmitting, by the network to the particular UE, a first downlink transmission via the first CC based on the first downlink control information parameter; and
transmitting, by the network to the particular UE, a second downlink transmission via the second CC based on the second downlink control information parameter.

29. The method of claim 28, wherein the multiple CC scheduling information comprises a list of parameter values configured to indicate scheduling parameter information for a particular downlink scheduling parameter for the multiple CCs.

30. The method of claim 28, wherein the multiple CC signaling message includes second multiple CC scheduling information configured to indicate second scheduling parameter information for a second downlink scheduling parameter for the multiple CCs.

31. (canceled)

32. The method of claim 28, wherein the multiple CC signaling message comprises a radio resource control (RRC) transmission or a medium access control control element (MAC CE) transmission.

33-34. (canceled)

35. The method of claim 28, wherein the first and second downlink transmissions have different data or the same data.

36. (canceled)

37. The method of claim 28, further comprising transmitting, by a first network entity of the network to a second network entity of the network, the second downlink control information parameter.

38. The method of claim 28, further comprising transmitting, by the network to the particular UE, a new multiple CC list or list update.

39-40. (canceled)

41. An apparatus configured for wireless communication, comprising:
at least one processor; and
a memory coupled to the at least one processor,
wherein the at least one processor is configured to:
receive, by a user equipment (UE) from a first network entity, a multiple component carrier (CC) signaling message including multiple CC scheduling information;
receive, by the UE from the first network entity, a downlink control information transmission indicating a downlink control information indication for multiple CCs;
determine, by the UE, a first downlink control information parameter for a first CC and a second downlink control information parameter for a second CC based on the downlink control information indication and the multiple CC scheduling information;
receive, by the UE from the first network entity, a first downlink transmission for the first CC based on the first downlink control information parameter; and
receive, by the UE from a second network entity, a second downlink transmission for the second CC based on the second downlink control information parameter.

42-46. (canceled)

47. An apparatus configured for wireless communication, comprising:
at least one processor; and
a memory coupled to the at least one processor,
wherein the at least one processor is configured to:
transmit, by a network to a particular user equipment (UE), a multiple component carrier (CC) signaling message including multiple CC scheduling information;
generate, by the network, a downlink control information indication configured to indicate a first downlink control information parameter for a first CC and a second downlink control information parameter for a second CC based on the multiple CC scheduling information;
transmit, by the network, a downlink control information transmission including the downlink control information indication;
transmit, by the network to the particular UE, a first downlink transmission via the first CC based on the first downlink control information parameter; and
transmit, by the network to the particular UE, a second downlink transmission via the second CC based on the second downlink control information parameter.
